(19) United States
(12) Patent Application Publication
(10) Pub. No.: US 2017/0352067 A1
(43) Pub. Date: Dec. 7, 2017

(54) Systems And Methods Of Raising Capital For Charities Through A Charity Bidding Platform

(71) Applicant: Simon MANDEL, New York, NY (US)

(72) Inventor: Simon MANDEL, New York, NY (US)

(21) Appl. No.: 15/613,441

(22) Filed: Jun. 5, 2017

Related U.S. Application Data
(60) Provisional application No. 62/344,994, filed on Jun. 3, 2016.

(51) Int. Cl. G06Q 30/02; G06Q 30/06; G06Q 20/06; G06Q 20/10; G06Q 40/04; G06Q 30/08

(52) U.S. Cl. CPC G06Q 30/0279; G06Q 40/04; G06Q 30/08; G06Q 20/06; G06Q 20/102; G06Q 30/0601

(57) ABSTRACT

Method of raising capital for charities through a charity bidding platform comprising: receiving a charitable organization (CO) description; receiving from a fundraiser (FR) profile; generating a COs' directory and a FRs' catalog; receiving from a donor's dossier; storing the description, profile, and dossier in a service provider's database; receiving a FR request from to fund a fundraiser-specified amount (FSA) of a fundraiser-specified charitable organization (FSCO); determining a minimum monetary threshold amount (MMTA) to fund the FSA; receiving a donor's bid to fund the FSA; classifying the donor as a preferred donor (PD) if the bid meets the MMTA; generating a PDs' list; receiving the FR's selection of a fundraiser-chosen preferred donor (FCPD); receiving the FCPD's funding corresponding to a PD bid of the FCPD; receiving a confirmation that the FR met the FCPD; and, transmitting to the FSCO, the amount of funding corresponding to the PD bid of the FCPD.

### CROSS-REFERENCE TO RELATED APPLICATIONS

The present application claims priority to provisional U.S. patent application Ser. No. 62/344,994, filed Jun. 3, 2016 and entitled “An application which facilitates connections between participants of the dating/social network with the purpose of raising capital for charities,” the disclosure of which is incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention is related to computer systems, methods and non-transitory computer readable medium that raises capital for charities through a charity bidding platform. The present invention is also related to an auction process whereby a donor can decide upon the level of capital he or she wants to commit to secure a meeting or a date with a fundraiser of the donor's choice.

### BRIEF SUMMARY OF THE INVENTION

An embodiment of the present invention is a computer system comprising: at least one processor unit; at least one memory unit coupled to the at least one processor unit; and, computer readable instructions embodied in the memory unit and executable by the processor unit, wherein execution of the instructions by the processor unit causes the computing system to perform a method of raising capital for charities through a charity bidding platform, the method comprising: receiving from at least one charitable organization, a description of the charitable organization; storing the descriptions of each of the at least one charitable organizations, in a database of a service provider; generating a directory of the charitable organizations; receiving from at least one fundraiser, a profile of the fundraiser; storing the profiles of each of the at least one fundraisers, in the database of the service provider; generating a catalog of the fundraisers; receiving from at least one donor, a dossier of the donor; storing the dossiers of each of the at least one donors, in the database of the service provider; receiving a request from the at least one fundraiser, to fund a fundraiser-specified amount of a fundraiser-specified charitable organization; determining a minimum monetary threshold amount to fund the fundraiser-specified amount of the fundraiser-specified charitable organization; receiving a bid from the at least one donor, in response to the request to fund the fundraiser-specified amount of the fundraiser-specified charitable organization; classifying the at least one donor as a preferred donor if the bid meets the minimum monetary threshold amount; generating a list of the preferred donors; receiving from the at least one fundraiser, a selection of a fundraiser-chosen preferred donor; receiving from the fundraiser-chosen preferred donor, an amount of funding corresponding to a preferred donor bid of the fundraiser-chosen preferred donor; receiving a confirmation that the at least one fundraiser met the fundraiser-chosen preferred donor; and, transmitting to the fundraiser-specified charitable organization, the amount of funding corresponding to the preferred donor bid of the fundraiser-chosen preferred donor.

Another embodiment of the present invention is a method of managing a project of a client, the method comprising: receiving from at least one charitable organization, a description of the charitable organization; storing the descriptions of each of the at least one charitable organizations, in a database of a service provider; generating a directory of the charitable organizations; receiving from at least one fundraiser, a profile of the fundraiser; storing the profiles of each of the at least one fundraisers, in the database of the service provider; generating a catalog of the fundraisers; receiving from at least one donor, a dossier of the donor; storing the dossiers of each of the at least one donors, in the database of the service provider; receiving a request from the at least one fundraiser, to fund a fundraiser-specified amount of a fundraiser-specified charitable organization; determining a minimum monetary threshold amount to fund the fundraiser-specified amount of the fundraiser-specified charitable organization; receiving a bid from the at least one donor, in response to the request to fund the fundraiser-specified amount of the fundraiser-specified charitable organization; classifying the at least one donor as a preferred donor if the bid meets the minimum monetary threshold amount; generating a list of the preferred donors; receiving from the at least one fundraiser, a selection of a fundraiser-chosen preferred donor; receiving from the fundraiser-chosen preferred donor, an amount of funding corresponding to a preferred donor bid of the fundraiser-chosen preferred donor; receiving a confirmation that the at least one fundraiser met the fundraiser-chosen preferred donor; and, transmitting to the fundraiser-specified charitable organization, the amount of funding corresponding to the preferred donor bid of the fundraiser-chosen preferred donor.

Yet another embodiment of the present invention is a non-transitory computer readable medium having computer readable instructions embodied therein, the computer readable instructions being configured to implement a method of managing a project of a client when executed, the method comprising: receiving from at least one charitable organization, a description of the charitable organization; storing the descriptions of each of the at least one charitable organizations, in a database of a service provider; generating a directory of the charitable organizations; receiving from at least one fundraiser, a profile of the fundraiser; storing the profiles of each of the at least one fundraisers, in the database of the service provider; generating a catalog of the fundraisers; receiving from at least one donor, a dossier of the donor; storing the dossiers of each of the at least one donors, in the database of the service provider; receiving a request from the at least one fundraiser, to fund a fundraiser-specified amount of a fundraiser-specified charitable organization; determining a minimum monetary threshold amount to fund the fundraiser-specified amount of the fundraiser-specified charitable organization; receiving a bid from the at least one donor, in response to the request to fund the fundraiser-specified amount of the fundraiser-specified charitable organization; classifying the at least one donor as a preferred donor if the bid meets the minimum monetary threshold amount; generating a list of the preferred donors; receiving from the at least one fundraiser, a selection of a fundraiser-chosen preferred donor; receiving from the fundraiser-chosen preferred donor, an amount of funding corresponding to a preferred donor bid of the fundraiser-chosen preferred donor; receiving a confirmation that the at least one fundraiser met the fundraiser-chosen preferred donor; and, transmitting to the fundraiser-specified charitable organization, the amount of funding corresponding to the preferred donor bid of the fundraiser-chosen preferred donor.

In another embodiment of the present invention, the selection is a plurality of fundraiser-chosen preferred donors.

In yet another embodiment of the present invention, the at least one fundraiser determines the minimum monetary threshold amount.

In another embodiment of the present invention, the service provider determines the minimum monetary threshold amount.

In yet another embodiment of the present invention, wherein the method further comprising: receiving from the at least one fundraiser, a fundraiser-contributed amount of funding; and, transmitting to the fundraiser-specified charitable organization, the fundraiser-contributed amount of funding.

In another embodiment of the present invention, wherein the method further comprising: receiving from the at least one donor, an indication of the at least one donor purchasing a premium.

In yet another embodiment of the present invention, wherein the method further comprising: receiving from the at least one fundraiser, a notification of the at least one fundraiser setting a fixed donation amount; and, receiving from the at least one donor, a donor-pledged amount corresponding to the fixed donation amount.

In another embodiment of the present invention, wherein the method further comprising: receiving from a fundraiser computing device of the at least one fundraiser, a set of fundraiser-information; transmitting to the fundraiser computing device, a fundraiser-identifier; receiving from a fundraiser-chosen preferred donor computing device of the fundraiser-chosen preferred donor, a set of fundraiser-chosen preferred donor-information; and, transmitting to the fundraiser-chosen preferred donor computing device, a fundraiser-chosen preferred donor-identifier.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 is a swim-lane diagram of an embodiment of the present invention.

FIGS. 2A-B illustrates a process of raising capital for charities through a charity bidding platform. FIG. 2A continues to FIG. 2B.

FIG. 3 illustrates a computerized system of raising capital for charities through a charity bidding platform.

FIG. 4 is an example of a computing environment that can be utilized by embodiments of the present invention.

FIG. 5 illustrates an example of a computing system that can be configured to perform any of the processes of the present invention described herein.

### DETAILED DESCRIPTION OF THE INVENTION

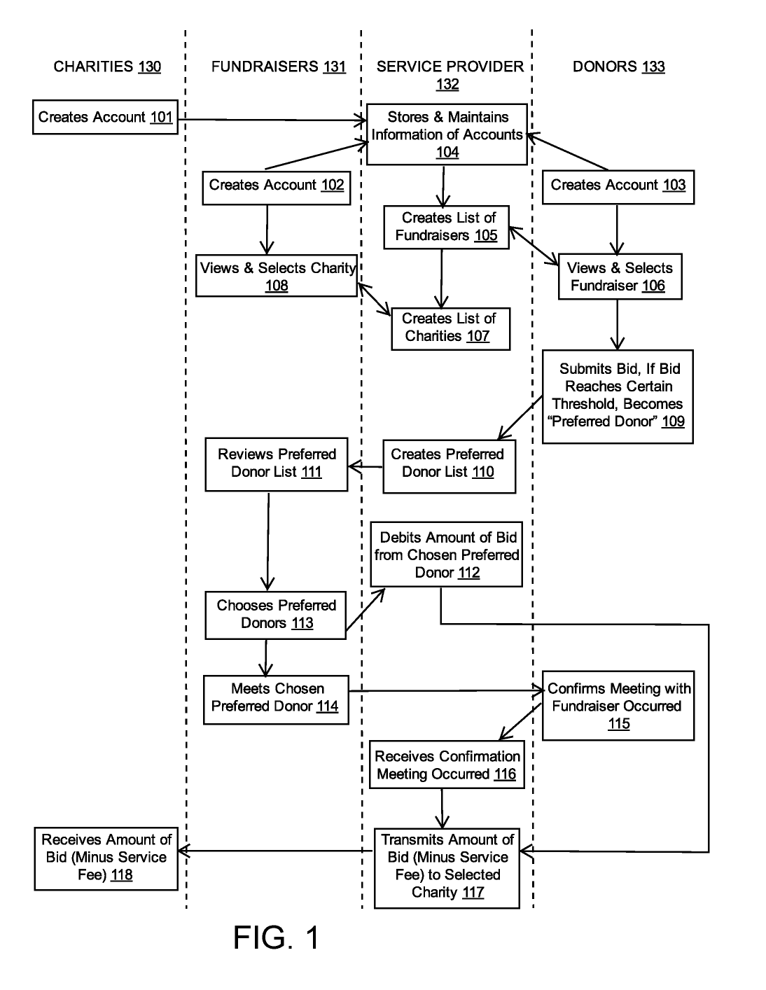

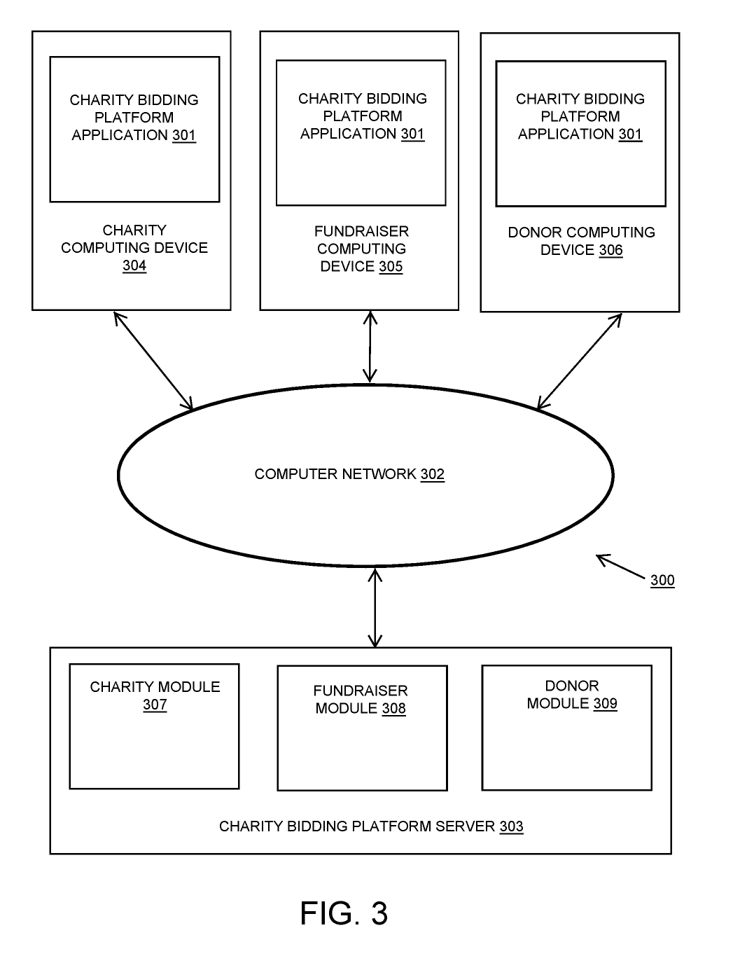

FIGS. 1 and 3 illustrate an embodiment of the present invention. Charities 130, fundraisers 131 and donors 133 access the charity bidding platform application 301 with an enabled computing device 304, 305, 306. The charities 130, fundraisers 131 and donors 133 create accounts (101, 102, 103). The service provider 132 stores and maintains information of accounts (104), creates a list of fundraisers 131 (105) and charities 130 (107).

A fundraiser 131 views and selects a charity 130 (108). A donor 133 views and selects a fundraiser 131 (106) and submit a bid and if the bid reaches a certain threshold, then the donor 133 becomes a preferred donor (109). The service provider 132 creates a preferred donor list (110) that the fundraiser 131 reviews (111).

The fundraiser 131 then chooses preferred donors (113). Once this occurs, the amount of the chosen donor's 133 bid is debited and the funds are held by the service provider 132 (112).

The fundraiser 131 and the chosen preferred donor then make their best efforts to meet. If they meet (114) and the meeting is confirmed (115), then the service provider 132 receives the confirmation (116). The service provider 132 then transmits the chosen donor's 133 bid (minus a service fee) to the charity 130 (117). The charity 130 then receives the funds (118).

FIG. 3 depicts a computerized system 300 of raising capital for charities through a charity bidding platform, according to some embodiments. System 300 may include one or more enabled computing devices 304, 305, 306. The enabled computing devices 304, 305, 306 may include such devices as tablet computers, smart phones, personal computers, laptop computers, scanners, game consoles and the like. The charity bidding platform application 301 may be software designed to help the charities 130 obtain funding by donors 133 bidding to win a meeting or date with fundraisers 131. The charity bidding platform application 301 may also communicate with the charity bidding platform server 303 through the computer network 302. The computer network 302 may be, for example, the internet.

The charity bidding platform server 303 may contain various modules, including the charity module 307, the fundraiser module 308 and the donor module 309. Each module 307, 308, 309 may store data. For example, the charity module 307 may store the charity's 130 background information (name, location, account number, login name, passwords, federal/IRS-approved tax identification number, charitable cause, among other information), and other information. The fundraiser module 308 may store information, details, and descriptions of the fundraiser's 131 background (name, location, account number, login name, passwords, pictures, biographies, among other information), and other information. Also, the donor module 309 may store the donor's 133 background (name, location, account number, login name, passwords, pictures, biographies, payment information, among other information), and other information. The donor module 309 may also contain a hyperlink to a third-party payer (e.g., PayPal) that allows the donor 133 to fund his or her bid amount. The charity bidding platform server 303 may contain various other modules not shown, such as, a service provider module that allows the service provider 132 maintain and store account information of charities 130, donors 133 and fundraisers 131; generate preferred donor lists; maintain escrow accounts; and, other information.

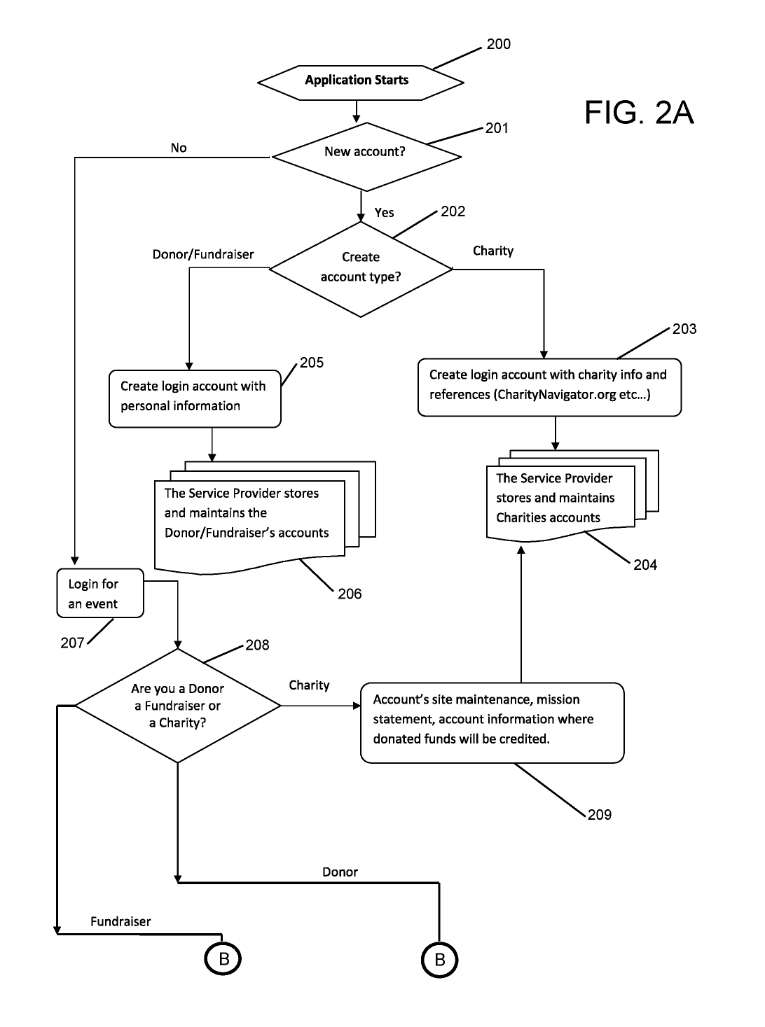

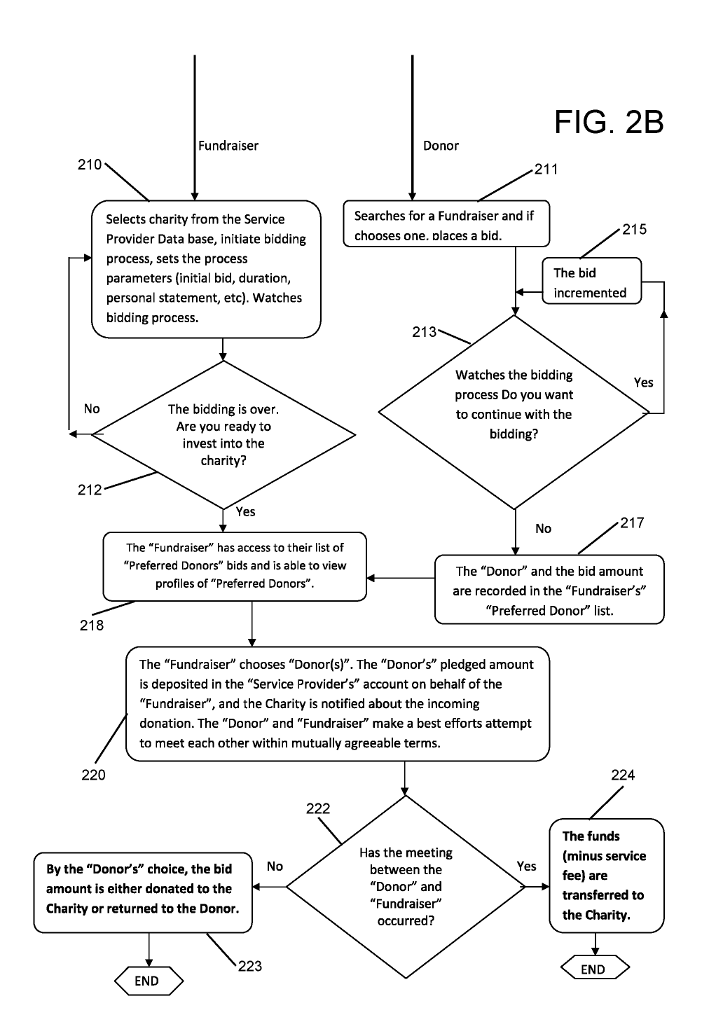

As illustrated in FIGS. 2A-B, an embodiment of the present invention is a computer system comprising: at least one processor unit; at least one memory unit coupled to the at least one processor unit; and, computer readable instructions embodied in the memory unit and executable by the processor unit, wherein execution of the instructions by the processor unit causes the computing system to perform a method of raising capital for charities through a charity bidding platform.

In an embodiment of the present invention, as further illustrated in FIGS. 2A-B, a user (e.g., fundraiser 131, donor 133 or charity 130) starts the charity bidding platform application (200). The user then responds to an account query to either create an account or log in to the application (201). The user then may create a new account (202). A charity 130 may create an account by providing information related to the charity 130 and references (203). The service provider 132 stores and maintains the charity 130 accounts (204). A donor 133 or fundraiser 131 may create an account by providing personal information (205). The service provider 132 stores and maintains the donor 133 and fundraiser 131 accounts (206).

The user then may login into an existing account (207). The user is then responds to a query as to the type of user (208). If the user is a charity 130, then the charity 130 is directed to its account's site maintenance that includes the charity's 130 mission statement and account information, such as, where donated funds will be credited (209).

If the user is a fundraiser 131, then the fundraiser 131 will select a charity 130 from the service provider 132 database. The fundraiser 131 will then initiate the bidding process, set the process parameters, such as initial bid, duration, and personal statement, and watches the bidding process (210). After the bidding has completed, the fundraiser 131 responds to a query as to whether the fundraiser 131 is ready to invest into the charity 130 (212). If the fundraiser 131 is not ready to invest into the charity 130, for any reason, then the fundraiser 131 may select another charity 130 (210). If the fundraiser 131 is ready to invest into the charity 130, then the fundraiser 131 is provided access to a list of preferred donors' bids and their profiles (218).

If the user is a donor 133, then the donor 133 searches and chooses a fundraiser 131, and places a bid (211). The donor 133 then watches the bidding (213) and may increase his or her bid (215). If the donor 133 has concluded the bidding process and if his or her bid meets or exceeds a minimum monetary threshold amount, then that donor 133 and the associated bid amount is recorded on the fundraiser's 131 preferred donor list (217).

The fundraiser 131 then chooses donors 133 from the preferred donor list and those donors' 133 pledged amounts are deposited in the service provider's 132 account on behalf of the fundraiser 131, and the charity 130 is notified of the donation; the donor 133 and fundraiser 131 communicate and make a best efforts attempt to meet each other within mutually agreeable terms (220).

Whether the meeting occurred is confirmed (222). If the meeting is confirmed, the donation funds, minus service fees, are transferred to the charity 130 (224). If the meeting is not confirmed, the donor 133 may elect to have the donation funds returned or given to the charity 130 (223).

In another embodiment of the present invention, the fundraiser 131 may select a plurality of fundraiser-chosen preferred donors. The fundraiser 131 is not restricted to choosing the highest bidder, nor just one preferred donor.

In yet another embodiment of the present invention, the fundraiser 131 may determine the minimum monetary threshold amount. Alternatively, the service provider 132 may determine the minimum monetary threshold amount. Similarly, the fundraiser 131 or the service provider 132 may set other parameters of the bidding process, such as the starting bid, duration of the bidding process, among other parameters.

In yet another embodiment of the present invention, the method of raising capital for charities through a charity bidding platform further comprises receiving from the fundraiser 131, a fundraiser-contributed amount of funding; and, transmitting to the fundraiser-specified charitable organization, the fundraiser-contributed amount of funding.

In another embodiment of the present invention, the method of raising capital for charities through a charity bidding platform further comprises receiving from the donor 133, an indication of the donor 133 purchasing a premium. The donor 133 has the option to purchase a premium, that ensures that the donor's 133 pledge is accepted by the fundraiser 131. The purchased premium is not visible to or known by the fundraiser 131 during the bidding process. If the donor 133 purchased the premium, but is not chosen by the fundraiser 131, at the end of the bidding process, the fundraiser 131 is notified of the premium and the fundraiser 131 and the donor 133 are put in communication, for instance, via chat.

In yet another embodiment of the present invention, the method of raising capital for charities through a charity bidding platform further comprises receiving from the fundraiser 131, a notification of the fundraiser 131 setting a fixed donation amount; and, receiving from the donor 133, a donor-pledged amount corresponding to the fixed donation amount. The fundraising process may be expedited by the fundraiser 131 by setting a fixed donation amount and when a donor 133 pledges that fixed amount, the fundraiser 131 and donor 133 are put in communication, for instance, via chat, for the purposes of arranging a meeting or date.

In another embodiment of the present invention, the method of raising capital for charities through a charity bidding platform further comprises receiving from a fundraiser computing device 305 of the fundraiser 131, a set of fundraiser-information; transmitting to the fundraiser computing device 305, a fundraiser-identifier; receiving from a fundraiser-chosen preferred donor computing device of the fundraiser-chosen preferred donor, a set of fundraiser-chosen preferred donor-information; and, transmitting to the fundraiser-chosen preferred donor computing device, a fundraiser-chosen preferred donor-identifier. Upon bid completion and the fundraiser's 131 selection of a winning bidder, a link created between the fundraiser 131 and the winning bidder (i.e., the fundraiser-chosen preferred donor). This enhances security and record verification. The charity bidding platform application 301 receives unique information from both the fundraiser computing device 305 and the winning bidder computing device. The information is received from the fundraiser's 131 and the winning bidder's hardware and software configurations and may include, but is not limited to, serial numbers, operating systems, and global positioning satellite locations. Based upon the received information, the charity bidding platform application 301 then transmits to the fundraiser computing device 305 a fundraiser-identifier and transmits to the winning bidder computing device a fundraiser-chosen preferred donor-identifier. The fundraiser-identifier is unique based upon the information received from that particular fundraiser; and, the fundraiser-chosen preferred donor-identifier is unique based upon the information received from that particular winning bidder. The fundraiser-identifier and the fundraiser-chosen preferred donor-identifier are complementary, meaning that when the fundraiser 131 with the possession of the fundraiser computing device (with the fundraiser-identifier) comes in close proximity to the winning bidder with the possession of the winning bidder computing device (with the fundraiser-chosen preferred donor-identifier), each of the fundraiser computing device 305 and the winning bidder computing device will transmit a confirmation to the service provider 132 through the charity bidding platform application 301 that the fundraiser 131 and the winning bidder are in close proximity, i.e., they are meeting.

The charity bidding platform application 301 may further transmit a unique QR code to the fundraiser computing device 305 and when the fundraiser 131 meets the winning bidder, the winning bidder may scan the fundraiser's 131 unique QR code with the winning bidder computing device, thereby confirming that the fundraiser 131 and the winning bidder have met. The charity bidding platform application 301 may also transmit a unique QR code to the winning bidder computing device and when the winning bidder meets the fundraiser 131, the fundraiser 131 may scan the winning bidder's unique QR code with the fundraiser computing device 305, thereby confirming that the winning bidder and the fundraiser 131 have met.

Another embodiment of the present invention is a non-transitory computer readable medium having computer readable instructions embodied therein, the computer readable instructions being configured to implement a method of managing a project of a client when executed. “Non-transitory computer readable medium” may not include a transitory signal.

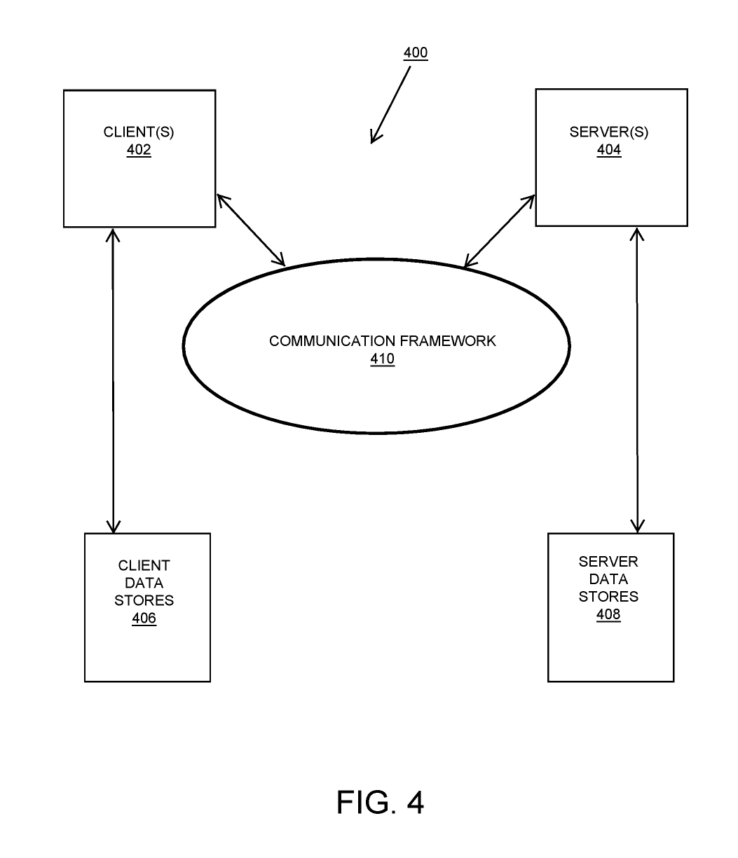

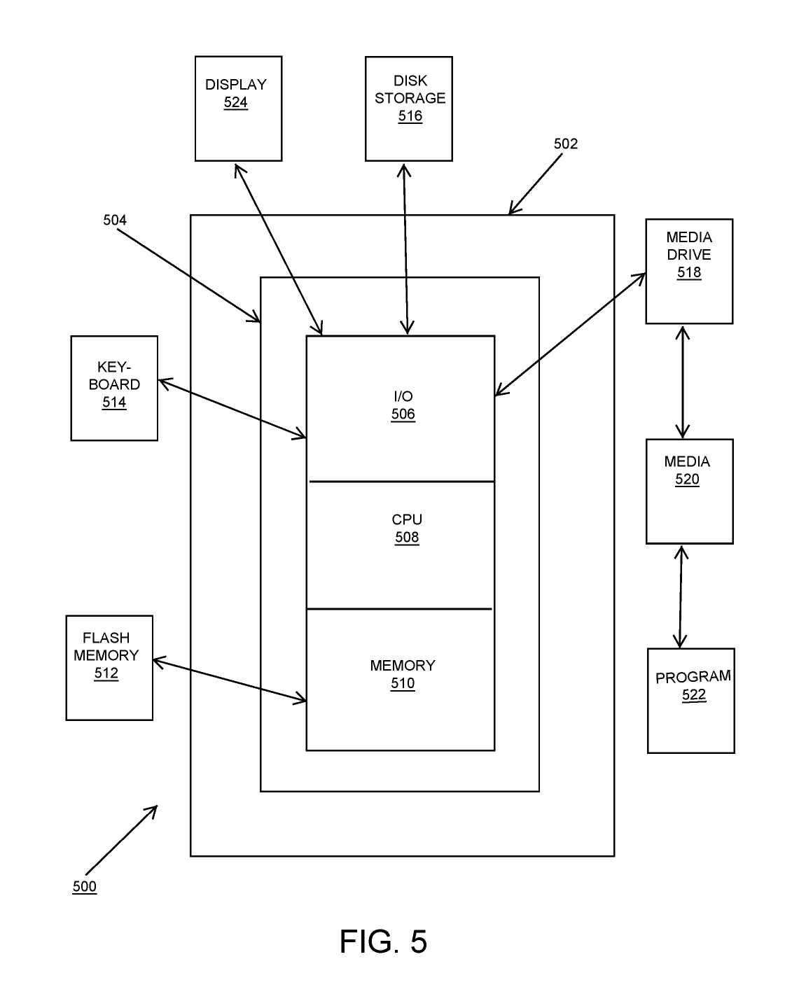

FIGS. 4 and 5 illustrate exemplary computing environments, devices and architectures for the implementation of the various embodiments of the present invention.

FIG. 4 illustrates a sample computing environment 400 that can be utilized in some embodiments. The system 400 further illustrates a system that includes one or more client(s) 402. The client(s) 402 can be hardware and/or software (e.g., threads, processes, computing devices). The system 400 also includes one or more server(s) 404, such as charity bidding platform server 303. The server(s) 404 can also be hardware and/or software (e.g., threads, processes, computing devices). One possible communication between a client 402 and a server 404 may be in the form of a data packet adapted to be transmitted between two or more computer processes. The system 400 includes a communication framework 410 that can be utilized to facilitate communications between the client(s) 402 and the server(s) 404. The client(s) 402 are connected to one or more client data store(s) 406 that can be employed to store information local to the client(s) 402. Similarly, the server(s) 404 are connected to one or more server data store(s) 408 that can be employed to store information local to the server(s) 404.

FIG. 5 depicts an exemplary computing system 500 that can be configured to perform any one of the above-described processes. In this context, computing system 500 may include, for example, a processor, memory, storage, and I/O devices (e.g., monitor, keyboard, disk drive, Internet connection, etc.). However, computing system 500 may include circuitry or other specialized hardware for carrying out some or all aspects of the processes. In some operational settings, computing system 500 may be configured as a system that includes one or more units, each of which is configured to carry out some aspects of the processes either in software, hardware, or some combination thereof.

FIG. 5 depicts computing system 500 with a number of components that may be used to perform the above-described processes. The main system 502 includes a motherboard 504 having an I/O section 506, one or more central processing units (CPU) 508, and a memory section 510, which may have a flash memory card 512 related to it. The I/O section 506 is connected to a display 524, a keyboard 514, a disk storage unit 516, and a media drive unit 518. The media drive unit 518 can read/write a computer-readable medium 520, which can contain programs 522 and/or data. Although, not shown, in some embodiments, computing system 500 can include an eye-tracking system and/or be coupled with an eye-tracking system.

I claim:

1. A computer system comprising:
at least one processor unit;
at least one memory unit coupled to the at least one processor unit; and,
computer readable instructions embodied in the memory unit and executable by the processor unit, wherein execution of the instructions by the processor unit causes the computing system to perform a method of raising capital for charities through a charity bidding platform, the method comprising:
receiving from at least one charitable organization, a description of the charitable organization;
storing the descriptions of each of the at least one charitable organizations, in a database of a service provider;
generating a directory of the charitable organizations;
receiving from at least one fundraiser, a profile of the fundraiser;
storing the profiles of each of the at least one fundraisers, in the database of the service provider;
generating a catalog of the fundraisers;
receiving from at least one donor, a dossier of the donor;
storing the dossiers of each of the at least one donors, in the database of the service provider;
receiving a request from the at least one fundraiser, to fund a fundraiser-specified amount of a fundraiser-specified charitable organization;
determining a minimum monetary threshold amount to fund the fundraiser-specified amount of the fundraiser-specified charitable organization;
receiving a bid from the at least one donor, in response to the request to fund the fundraiser-specified amount of the fundraiser-specified charitable organization;
classifying the at least one donor as a preferred donor if the bid meets the minimum monetary threshold amount;
generating a list of the preferred donors;
receiving from the at least one fundraiser, a selection of a fundraiser-chosen preferred donor;
receiving from the fundraiser-chosen preferred donor, an amount of funding corresponding to a preferred donor bid of the fundraiser-chosen preferred donor;
receiving a confirmation that the at least one fundraiser met the fundraiser-chosen preferred donor; and,
transmitting to the fundraiser-specified charitable organization, the amount of funding corresponding to the preferred donor bid of the fundraiser-chosen preferred donor.

2. The computer system of claim 1, wherein the selection is a plurality of fundraiser-chosen preferred donors.

3. The computer system of claim 2, wherein the at least one fundraiser determines the minimum monetary threshold amount.

4. The computer system of claim 2, wherein the service provider determines the minimum monetary threshold amount.

5. The computer system of claim 1, the method further comprising:
receiving from the at least one fundraiser, a fundraiser-contributed amount of funding; and,
transmitting to the fundraiser-specified charitable organization, the fundraiser-contributed amount of funding.

6. The computer system of claim 1, the method further comprising:
receiving from the at least one donor, an indication of the at least one donor purchasing a premium.

7. The computer system of claim 1, the method further comprising:
receiving from the at least one fundraiser, a notification of the at least one fundraiser setting a fixed donation amount; and,
receiving from the at least one donor, a donor-pledged amount corresponding to the fixed donation amount.

8. The computer system of claim 1, the method further comprising:
receiving from a fundraiser computing device of the at least one fundraiser, a set of fundraiser-information;
transmitting to the fundraiser computing device, a fundraiser-identifier;
receiving from a fundraiser-chosen preferred donor computing device of the fundraiser-chosen preferred donor, a set of fundraiser-chosen preferred donor-information; and,
transmitting to the fundraiser-chosen preferred donor computing device, a fundraiser-chosen preferred donor-identifier.

9. A method of raising capital for charities through a charity bidding platform, the method comprising:
receiving from at least one charitable organization, a description of the charitable organization;
storing the descriptions of each of the at least one charitable organizations, in a database of a service provider;
generating a directory of the charitable organizations;
receiving from at least one fundraiser, a profile of the fundraiser;
storing the profiles of each of the at least one fundraisers, in the database of the service provider;
generating a catalog of the fundraisers;
receiving from at least one donor, a dossier of the donor;
storing the dossiers of each of the at least one donors, in the database of the service provider;
receiving a request from the at least one fundraiser, to fund a fundraiser-specified amount of a fundraiser-specified charitable organization;
determining a minimum monetary threshold amount to fund the fundraiser-specified amount of the fundraiser-specified charitable organization;
receiving a bid from the at least one donor, in response to the request to fund the fundraiser-specified amount of the fundraiser-specified charitable organization;
classifying the at least one donor as a preferred donor if the bid meets the minimum monetary threshold amount;
generating a list of the preferred donors;
receiving from the at least one fundraiser, a selection of a fundraiser-chosen preferred donor;
receiving from the fundraiser-chosen preferred donor, an amount of funding corresponding to a preferred donor bid of the fundraiser-chosen preferred donor;
receiving a confirmation that the at least one fundraiser met the fundraiser-chosen preferred donor; and,
transmitting to the fundraiser-specified charitable organization, the amount of funding corresponding to the preferred donor bid of the fundraiser-chosen preferred donor.

10. The method of managing a project of a client of claim 9, wherein the selection is a plurality of fundraiser-chosen preferred donors.

11. The method of managing a project of a client of claim 10, wherein the at least one fundraiser determines the minimum monetary threshold amount.

12. The method of managing a project of a client of claim 10, wherein the service provider determines the minimum monetary threshold amount.

13. The method of managing a project of a client of claim 9, further comprising:
receiving from the at least one fundraiser, a fundraiser-contributed amount of funding; and,
transmitting to the fundraiser-specified charitable organization, the fundraiser-contributed amount of funding.

14. The method of managing a project of a client of claim 9, further comprising:
receiving from the at least one donor, an indication of the at least one donor purchasing a premium.

15. The method of managing a project of a client of claim 9, further comprising:
receiving from the at least one fundraiser, a notification of the at least one fundraiser setting a fixed donation amount; and,
receiving from the at least one donor, a donor-pledged amount corresponding to the fixed donation amount.

16. The method of managing a project of a client of claim 9, the method further comprising:
receiving from a fundraiser computing device of the at least one fundraiser, a set of fundraiser-information;
transmitting to the fundraiser computing device, a fundraiser-identifier;
receiving from a fundraiser-chosen preferred donor computing device of the fundraiser-chosen preferred donor, a set of fundraiser-chosen preferred donor-information; and,
transmitting to the fundraiser-chosen preferred donor computing device, a fundraiser-chosen preferred donor-identifier.

17. A non-transitory computer readable medium having computer readable instructions embodied therein, the computer readable instructions being configured to implement a method of raising capital for charities through a charity bidding platform when executed, the method comprising:
receiving from at least one charitable organization, a description of the charitable organization;
storing the descriptions of each of the at least one charitable organizations, in a database of a service provider;
generating a directory of the charitable organizations;
receiving from at least one fundraiser, a profile of the fundraiser;
storing the profiles of each of the at least one fundraisers, in the database of the service provider;
generating a catalog of the fundraisers;
receiving from at least one donor, a dossier of the donor;
storing the dossiers of each of the at least one donors, in the database of the service provider;
receiving a request from the at least one fundraiser, to fund a fundraiser-specified amount of a fundraiser-specified charitable organization;
determining a minimum monetary threshold amount to fund the fundraiser-specified amount of the fundraiser-specified charitable organization;
receiving a bid from the at least one donor, in response to the request to fund the fundraiser-specified amount of the fundraiser-specified charitable organization;
classifying the at least one donor as a preferred donor if the bid meets the minimum monetary threshold amount;
generating a list of the preferred donors;
receiving from the at least one fundraiser, a selection of a fundraiser-chosen preferred donor;
receiving from the fundraiser-chosen preferred donor, an amount of funding corresponding to a preferred donor bid of the fundraiser-chosen preferred donor;
receiving a confirmation that the at least one fundraiser met the fundraiser-chosen preferred donor; and,
transmitting to the fundraiser-specified charitable organization, the amount of funding corresponding to the preferred donor bid of the fundraiser-chosen preferred donor.
